(19) United States
(12) Patent Application Publication
(10) Pub. No.: US 2022/0033604 A1
(43) Pub. Date: Feb. 3, 2022

(54) PUMPABLE, THERMALLY CURABLE AND EXPANDABLE PREPARATIONS

(71) Applicant: Henkel AG & Co. KGaA, Duesseldorf (DE)

(72) Inventors: Rainer Kohlstrung, Plankstadt (DE); Klaus Rappmann, Weinheim-Rittenweier (DE)

(21) Appl. No.: 17/450,858

(22) Filed: Oct. 14, 2021

Related U.S. Application Data
(63) Continuation of application No. PCT/EP2020/059954, filed on Apr. 8, 2020.

(30) Foreign Application Priority Data
Apr. 16, 2019 (EP) 19169374.6

(51) Int. Cl. C08J 9/00; C08J 9/10; B29C 44/18; C08K 5/14; B29C 44/42

(52) U.S. Cl. CPC C08J 9/0061; C08J 9/103; C08J 9/105; B29C 44/188; C08K 5/14; B29C 44/42; C08J 2447/00; C08J 2333/10; C08J 2333/08; C08J 2333/14; C08J 2323/08; C08J 2201/026; C08J 2203/04; C08J 2423/22

(57) ABSTRACT

A thermally expandable preparation pumpable at application temperatures in the range of 50 to 120° C., is provided containing: at least one polymer selected from binary copolymers containing at least one monomer unit selected from vinyl acetate, (meth)acrylic acids, styrene and derivatives thereof, and terpolymers based on at least one first monomer selected from the monounsaturated or polyunsaturated hydrocarbons, and at least one second monomer selected from (meth)acrylic acids and derivatives thereof, and at least one third monomer selected from epoxy-functionalized (meth)acrylates, as well as combinations of the first two; at least one liquid polymer selected from liquid hydrocarbon resins, liquid polyolefins and liquid polymers based on one or more diene monomers; at least one peroxide; at least one thermally activatable blowing agent; and at least one adhesion promoter; as well as methods to stiffen/reinforce or seal structural components by application of the preparation.

The present application relates to a preparation that is pumpable, thermally curable and expandable at application temperatures, typically in the range of 50 to 120° C., and contains the constituents disclosed herein, to a method for stiffening structural components having thin-walled structures using such preparations or for sealing cavities in structural components using such preparations, and to the use of these preparations for stiffening such structures or for sealing cavities in structural components.

Modern vehicles and vehicle parts have a large number of cavities which have to be sealed to prevent the entry of moisture and dirt, since this can lead to corrosion of the corresponding body parts from the inside out. This applies in particular to modern self-supporting body structures in which a heavy frame construction is replaced by lightweight, structurally stable frameworks made of prefabricated cavity profiles. As a result of this system, structures of this kind have a series of cavities that have to be sealed against the ingress of moisture and dirt. Seals of this kind are also used for the purpose of preventing the transmission of airborne sound in cavities of this kind, and thus to reduce unpleasant vehicle running noises and wind noises and thus to increase the driving comfort in the vehicle.

Frame and body parts containing such cavities can, for example, be prefabricated from half-shell structural components which are joined to form the closed hollow profile at a later point in time by welding and/or gluing. With such a construction, the cavity is therefore easily accessible in the early construction stage of a vehicle body, so that sealing and acoustically damping baffle parts can be fixed in this phase of the body assembly by mechanical hanging, by insertion into corresponding holding devices, or bores, or by welding. Furthermore, such hollow profiles can be produced from steel, aluminum or plastics materials in the extrusion process, by hydroforming, by die casting or by drawing processes. The resulting cavities are only accessible through the cross-sectional openings at the end of these profiles.

Baffle parts that cause a sealing and/or acoustic effect in cavities of this kind are often referred to as “pillar fillers,” “baffles” or “acoustic baffles.” They usually consist either completely of thermally expandable molded bodies or of molded bodies containing a carrier and expandable polymeric preparations in the peripheral region thereof. These baffle parts are fastened to the open structures by means of hanging, clipping, screwing or welding during body assembly. After closing the structures during body assembly and further pretreating the body, the process heat of the furnaces for curing the cathodic dip paint is then used to trigger the expansion of the expandable part of the baffle part in order to thus seal the cross section of the cavity.

Moreover, for many fields of application, there is need for lightweight structural components that are intended for dimensionally consistent batch production and have high rigidity and structural strength. In vehicle construction in particular, given the desire to reduce weight, there is great need for lightweight structural components consisting of thin-walled structures which nevertheless have adequate rigidity and structural strength. One way to achieve high rigidity and structural strength while keeping the weight of the structural component as low as possible is to use hollow parts made from relatively thin sheet metal or plastics sheets. However, thin-walled sheet metal tends to deform easily. Therefore, in the case of hollow body structures, it has been known for some time to fill the cavity with a structural foam, completely or only partially, for example in portions subject to particularly high levels of mechanical stress. This can result in deformations or distortions being minimized, or even completely prevented, and in the strength and rigidity of the hollow body structures being increased.

Such foamed reinforcing and stiffening agents are usually either metal foams or are made from thermally curable and expandable preparations, for example based on epoxy resins. In the latter case, the preparations are usually provided in the form of thermally curable and expandable molded bodies based on reactive epoxy resins which are produced by means of conventional injection molding techniques. Such molded bodies are each precisely matched to the desired application in terms of their spatial design. As part of the production of the lightweight structural components, the curable and expandable molded bodies are then introduced on site into the structural components to be reinforced, and cured and foamed in a separate method step by heating (for example as part of the painting process). Such molded bodies and their use are described, for example, in the context of WO-A1-2004/065485. However, with this procedure, a correspondingly designed molded article and the injection molds necessary for its production have to be developed in a complex manner for each structural component to be reinforced; flexible use of these reinforcing agents is thus almost impossible.

Furthermore, this method has the disadvantage that the preparation, which is solid at room temperature, has to be heated to produce the molded bodies, which under certain circumstances can lead to the irreversible, highly exothermic curing process already being initiated. In some cases, a small amount of curing of the systems is even consciously accepted in order to optimize the dimensional stability and surface quality of the molded bodies.

Alternatively, for example, in WO-A2-2002/31077 two-component systems for stiffening structural components have been proposed, which systems cure at room temperature. However, such systems involve increased risks with regard to the dosing accuracy, which has a negative impact on both the expansion rate and the resulting mechanical properties. In addition, such systems which cure at room temperature result in structural foams which are inferior to the hot-cured systems in terms of their thermomechanical properties.

As a third alternative, paste-like structural adhesives can be used. However, these have the disadvantage of insufficient stability, in particular when they are applied in greater layer thicknesses. In addition, such paste-like structural adhesives tend to flow out of the targeted area of application during the heating process and thus do not tend to develop their full effectiveness at the desired point. Another disadvantage is the low resistance to washing off in certain applications and insufficient expansion to fill the cavities.

Accordingly, it was the object of the present invention to provide preparations for the production of structural foams for locally reinforcing and sealing (hollow) structural components which overcome the disadvantages mentioned above.

Surprisingly, it has now been found that thermally expandable preparations which contain the combination of resins described herein demonstrate such behavior that good applicability by means of conventional pumps is ensured, and also the applied preparation already has sufficient stability before curing, so that the preparation is prevented from slipping out of the application area prior to curing or during the heating process. In addition, the cured preparations are characterized by very high expansion rates of 250% and more as well as mechanical properties which correspond to those of conventional stiffening foams based on solid molded bodies.

The present invention therefore firstly relates to preparations that are pumpable and thermally expandable at application temperatures in the range of 50 to 120° C., and contain, in each case based on the total weight of the preparation:
a) 3 to 40 wt. % of at least one polymer, preferably peroxidically crosslinkable polymer, selected from (a1) binary copolymers containing at least one monomer unit selected from vinyl acetate, (meth)acrylic acids, styrene and derivatives thereof, and (a2) terpolymers based on at least one first monomer selected from the monounsaturated or polyunsaturated hydrocarbons, in particular ethylene, and at least one second monomer selected from the (meth)acrylic acids and derivatives thereof, in particular (meth)acrylic esters, and at least one third monomer selected from epoxy-functionalized (meth)acrylates, in particular glycidyl (meth)acrylate, and combinations of (a1) and (a2);
b) 1 to 40 wt. % of at least one liquid polymer selected from liquid (b1) hydrocarbon resins, (b2) liquid polyolefins and (b3) liquid polymers based on one or more diene monomers;
c) 0.1 to 6 wt. % of at least one peroxide;
d) 0.1 to 20 wt. % of at least one thermally activatable blowing agent;
e) 1 to 12 wt. % of at least one adhesion promoter, in particular selected from pre-crosslinked rubbers, preferably highly crosslinked butyl rubber; and
f) 0 to 6 wt. % of at least one co-crosslinking agent selected from multifunctional (meth)acrylates, in particular low-molecular-weight multifunctional (meth)acrylates.

“At least one,” as used herein, means one or more, i.e., 1, 2, 3, 4, 5, 6, 7, 8, 9 or more. In relation to an ingredient, the expression refers to the type of ingredient and not to the absolute number of molecules. “At least one polymer” thus means, for example, at least one type of polymer, i.e., one type of polymer or a mixture of a plurality of different polymers can be meant. Together with weight specifications, the expression relates to all compounds of the type indicated that are contained in the composition/mixture, i.e., the composition does not contain any other compounds of this type beyond the indicated amount of the corresponding compounds.

“Liquid” means that the corresponding compound/component, under standard conditions, i.e., 20° C. and 1013 mbar, is in liquid form, preferably having a viscosity of up to 250 Pa*s at 20° C., and in particular is flowable and thus, for example, can be poured out of a container. Unless stated otherwise, the viscosities are determined in the context of the present application under the following measurement conditions: rotation rheometer having a plate-plate geometry (PP20); measured in oscillation at 10% deformation and a frequency of 100 rad/s; layer thickness of the material=0.2 mm.

A substance is “solid” if it is in the solid state of aggregation at 20° C. and 1013 mbar. The substance is in a solid state of aggregation if the geometry of the substance does not deform under the influence of gravity within 1 hour, in particular within 24 hours, under the specified conditions.

Unless explicitly indicated otherwise, all percentages that are cited in connection with the preparations described herein relate to wt. %, in each case based on the relevant preparation or composition.

Numbers stated herein with no decimal places refer to the full specified value with one decimal place. For example, “99%” stands for “99.0%.” Numbers stated herein with no decimal places refer to the full specified value with one decimal place.

The terms “about” or “approximately” in connection with a numerical value refer to a variance of ±10% in relation to the specified numerical value.

Unless stated otherwise, the molecular weights indicated in the present text relate to the weight-average molecular weight (Mw). The molecular weight Mw can be determined by gel permeation chromatography (GPC) according to DIN 55672-1:2007-08 with polystyrene as the standard and THF as the eluent. Except where indicated otherwise, the listed molecular weights are those which are determined by means of GPC. The number average of the molecular weight Mn can also be determined by means of GPC, as indicated previously. Alternatively, Mn can also be determined on the basis of an end group analysis (hydroxyl number according to DIN 53240-1:2013-06) if the polymer allows this.

According to the invention, “preparations that are pumpable at application temperatures” are preparations which can be applied from a storage vessel to the application site at temperatures in the range of 50 to 120° C. using conventional pumps at a pressure of less than 200 bar, in particular of 6 to 180 bar. Preparations that can be applied from a storage vessel to the application site at application temperatures in the range of 50° C. to 60° C. using conventional pumps at a pressure of less than 200 bar, in particular of 6 to 180 bar, are particularly preferred.

Preparations according to the invention which are “pumpable at application temperatures” are very particularly preferred in the sense that said preparations have, at 60° C. and a pump pressure of 6 bar, a flow rate of at least 100 g/min, preferably of 150 g/min to 4,500 g/min, more preferably of 250 g/min to 3,000 g/min, when discharged from a completely filled, commercially available aluminum nozzle cartridge which has a capacity of 310 ml and an internal diameter of 46 mm, and the outlet opening of which has been opened by means of a cartridge piercing tool having an external diameter of 9 mm, without attaching a nozzle, at a temperature of 60° C. (after pre-heating for 45 minutes) and a pressure of 6 bar. The flow rate indicates the mass of preparation that can be discharged within 1 minute, and is accordingly given in g/min.

A first component essential to the invention is a peroxidically crosslinkable polymer which, in one embodiment, can be a binary copolymer containing at least one monomer unit selected from vinyl acetate, (meth)acrylic acids, styrene and derivatives thereof. A person skilled in the art uses the expression “peroxidically crosslinkable” to refer to polymers in which a hydrogen atom can be abstracted from the main chain or a side chain by the action of a radical initiator, such that a radical is left behind that acts on other polymer chains in a second reaction step. According to the invention, “binary copolymers” are understood to mean all copolymers which result from a polymerization reaction from two monomers which are different from one another. Of course, according to the invention, copolymers in the polymer chain of which further monomers, for example due to degradation reactions or impurities, are incorporated in such small amounts that they do not affect the properties of the binary copolymer, should also be included.

The peroxidically crosslinkable binary copolymer according to the invention contains at least one monomer unit selected from vinyl acetate, (meth)acrylic acids, styrene and derivatives thereof. As usual, the prefix “(meth)” before “acrylate” means that these monomers can be acrylic acids and/or derivatives thereof as well as methacrylic acids and/or derivatives thereof. Derivatives of (meth)acrylic acids are in particular (meth)acrylic esters; the alcohol component of the ester is preferably selected from those which contain 1 to 8 carbon atoms. Particularly preferred monomer units of this group are vinyl acetate, butyl acrylate, methyl acrylate, ethyl acrylate and 2-ethylhexyl acrylate. According to the invention, vinyl acetate is a particularly preferred representative of this group.

The second monomer of the binary copolymer (a1) according to the invention is preferably selected from the alkenes. Ethylene is a particularly preferred second monomer of the binary copolymer (a1) within the meaning of the present invention.

In a first preferred embodiment, the at least one peroxidically crosslinkable polymer is selected from styrene-butadiene block copolymers, styrene-isoprene block copolymers, ethylene-vinyl acetate copolymers, functionalized ethylene-vinyl acetate copolymers, functionalized ethylene-butyl acrylate copolymers, ethylene-methyl acrylate copolymers, ethylene-ethyl acrylate copolymers, ethylene-butyl acrylate copolymers, functionalized ethylene-butyl acrylate copolymers, ethylene-(meth)acrylic acid copolymers and ethylene-2-ethylhexyl acrylate copolymers. In a particularly preferred embodiment, the at least one peroxidically crosslinkable binary copolymer is selected from ethylene-vinyl acetate copolymers, functionalized ethylene-vinyl acetate copolymers, ethylene-butyl acrylate copolymers, functionalized ethylene-butyl acrylate copolymers, ethylene-methyl acrylate copolymers, ethylene-ethyl acrylate copolymers, ethylene-(meth)acrylic acid copolymers, and ethylene-2-ethylhexyl acrylate copolymers.

According to the invention, a “functionalized copolymer” is understood to be a copolymer which is provided with additional hydroxide groups, carboxyl groups, anhydride groups, acrylate groups and/or glycidyl methacrylate groups, preferably at the chain ends.

Ethylene-vinyl acetate copolymers, ethylene-butyl acrylate copolymers and functionalized derivatives thereof are particularly advantageous within the meaning of the present invention. Ethylene-vinyl acetate copolymers, in particular the representatives which have no functionalization, can be very particularly preferred according to the invention. Ethylene-vinyl acetate copolymers having a vinyl acetate proportion of 25-50 wt. %, based on the total mass of the binary copolymer, are very particularly preferably contained and are particularly preferred according to the invention.

In various embodiments, the peroxidically crosslinkable binary copolymers (a1) according to the invention are characterized by a melt flow index of up to 100 g/10 min, preferably in the range of 12 to 80 g/10 min. The melt flow index of the peroxidically crosslinkable polymers is determined according to the invention in a melt flow measuring device, the polymer being melted at 190° C. in a heatable cylinder and being pushed through a defined standard nozzle at a pressure produced by the bearing load (2.16 kg) (DIN EN ISO 1133). The mass of material being extruded is measured as a function of time. The melting temperature is preferably in the range of 40 to 93° C.

According to the invention, the thermally expandable preparations preferably contain up to 25 wt. % of at least one or more of the peroxidically crosslinkable binary copolymers (a1) according to the invention. Thermally expandable preparations containing 7 to 16 wt. % of at least one or more of the peroxidically crosslinkable binary copolymers (a1), in each case based on the total mass of the thermally expandable preparation, are particularly preferred.

Alternatively or additionally, the component (a) can at least one terpolymer (a2) based on at least one first monomer selected from the monounsaturated or polyunsaturated hydrocarbons, at least one second monomer selected from the (meth)acrylic acids and derivatives thereof, and at least one third monomer selected from epoxy-functionalized (meth)acrylates.

According to the invention, it has proven to be preferred if the first monomer unit of the terpolymer is a monounsaturated or polyunsaturated acyclic hydrocarbon; alkenes and dienes are particularly preferred representatives of this group; according to the invention, the monomer units ethylene, propylene, 1,2-butadiene, 1,3-butadiene and isoprene are very particularly preferred representatives of this group, with ethylene being most preferred.

The second comonomer of the terpolymer is selected from (meth)acrylic acid and derivatives thereof. As usual, the prefix “(meth)” before “acrylate” means that these monomers can be acrylic acids and/or acrylic esters as well as methacrylic acids and/or methacrylic esters. If the terpolymer according to the invention contains acrylic esters and/or methacrylic esters, the alcohol component of the ester is preferably selected from those containing 1 to 6 carbon atoms. In particular, methyl esters, ethyl esters and butyl esters can be used.

In a preferred embodiment of the present invention, the third comonomer of the component (e) is selected from glycidyl (meth)acrylic esters.

According to the invention, glycidyl (meth)acrylic esters are understood to mean the esters of acrylic acid or methacrylic acid with glycidol (2,3-epoxypropan-1-ol).

Terpolymers of ethylene with (meth)acrylic esters, in particular methyl acrylate and butyl acrylate, and glycidyl (meth)acrylic esters, in particular glycidyl methacrylate, are particularly preferred. The proportion of (meth)acrylic esters is preferably 10 to 30 wt. %, preferably 20 to 30 wt. %, and the proportion of glycidyl (meth)acrylic esters is preferably 5 to 20 wt. %, preferably 5 to 10 wt. %, with the remainder ethylene, in each case based on the total weight of the terpolymer. Ethylene-butyl acrylate-glycidyl methacrylate and ethylene-methyl acrylate-glycidyl methacrylate terpolymers, and mixtures thereof, are preferred.

Even if the component (a2) is defined according to the invention as a terpolymer, the invention should of course also include copolymers that contain other monomers, for example from degradation reactions or impurities, in such small amounts that they do not affect the properties of the terpolymers according to the invention.

The use of the copolymers/terpolymers according to the invention of the component (a) in the preparations according to the invention allows better stability of the preparations during the heating of the material that is necessary for curing/expansion. In addition, it was surprisingly found that the use of these copolymers/terpolymers allows uniform expansion even at different temperatures, i.e., that the degree of expansion of preparations containing these copolymers/terpolymers varies less than with conventional preparations under underfiring, ideal and overfiring conditions.

In various embodiments, the terpolymer (a2) has a melt flow index of 1 to 10 g/10 min, which is determined in accordance with DIN EN ISO 1133 and with a test load of 2.16 kg and a test temperature of 190° C. The melt index is determined in a capillary rheometer as described above. The melting temperature is preferably in the range of 40 to 93° C., for example in the range of 70 to 80° C.

In various embodiments of the invention, the copolymer (a1) and the terpolymer (a2) can also be used in combination, and this can be preferred. The stated total amount of (a) is not exceeded, but the two constituents are used in the abovementioned preferred amounts.

When contained, the polymers (a) are contained in the thermally expandable preparations preferably in an amount of 3 to 40 wt. %, in particular in each case of 3 to 16 wt. %, very particularly preferably of 7 to 16 wt. %, in each case based on the total mass of the thermally expandable preparation. It is particularly preferred to use one or more terpolymers (a2) in an amount of 10 to 25 wt. %, preferably 12 to 20 wt. %. The total amount of the polymer (a) is up to 40 wt. %, preferably up to 30 wt. %, particularly preferably 10 to 25 wt. %.

A combination of at least two terpolymers (a2) is very particularly preferred, the first being ethylene-butyl acrylate (20-30 wt. %)-glycidyl methacrylate (6-9 wt. %) and the second being ethylene-methyl acrylate (20-30 wt. %)-glycidyl methacrylate (6-9 wt. %), in an amount of 10 to 20 wt. % or 5 to 10 wt. %, the total amount of the terpolymer (a2) being 15 to 25 wt. %.

The thermally expandable preparations described herein also contain at least one liquid polymer as a second component that is essential to the invention. “Liquid,” as used in this context, has the meaning given above and relates to the state under standard conditions, i.e., in particular temperatures in the room temperature range of approximately 20° C.

The liquid polymer (b) can be a hydrocarbon resin (b1), a polyolefin (b2) or a polymer based on diene monomers (b3). Combinations of different such polymers are also included.

According to the invention, “hydrocarbon resins” (b1) denote, inter alia, thermoplastic polymers that can be obtained from petroleum fractions. These can, for example, have an average molar mass of at most 2,500 g/mol. In the context of the present application, the average molar mass of polymers is generally understood to mean the weight-average molar mass. In the context of the present invention, the weight average molecular weight (M_{w}) can be determined by means of gel permeation chromatography (GPC) with polystyrene as the standard, as defined above.

The hydrocarbon resins (b1) can be completely aliphatic or completely aromatic, or they can have aliphatic and aromatic structures. They can also be aromatically modified aliphatic resins.

If contained, the hydrocarbon resins are preferably contained in the thermally expandable preparations in an amount of up to 35 wt. %, in particular of 5 to 35 wt. %, very particularly preferably of 10 to 25 wt. %, in each case based on the total mass of the thermally expandable preparation.

The liquid polymer can also be selected from liquid polyolefins (b2). Polyisobutylene is particularly preferred here, in particular having a molecular weight Mw of up to 3,000 g/mol. Such polymers, when they are contained in the preparations according to the invention, are preferably contained in amounts of up to 10 wt. %, preferably 3 to 8 wt. %.

Finally, the liquid polymer can also be a polymer based on one or more diene monomers (b3).

Although in principle there are no restrictions with regard to the diene monomers, it can be preferred if a polymer (b3) based on at least one alkadiene monomer is used. Homopolymers based on a diene monomer can be polymers (b3) which are particularly preferred according to the invention. Although the use of non-functionalized polymers (b3) is generally preferred, the polymers (b3) can in exceptional cases also be functionalized with additional hydroxide groups, carboxyl groups, anhydride groups, acrylate groups and/or glycidyl methacrylate groups, preferably at the chain ends.

Diene monomers that are particularly preferred according to the invention for the polymer (b3) are 1,2-butadiene, 1,3-butadiene and isoprene. According to the invention, 1,3-butadiene and isoprene are very particularly preferred diene monomers.

Furthermore, polymers (b3) have proven to be preferred which have an average molar mass of at least 25,000 g/mol. Polymers (b3) having an average molar mass of 25,000-60,000 g/mol can be particularly preferred according to the invention. In this context, the weight-average molar mass of polymers is understood to be the weight-average molar mass (M_{w}), which can be determined by means of gel permeation chromatography (GPC) using polystyrene as the standard.

In various embodiments, the polymer (b3) is selected from the group formed by the polybutadiene homopolymers, the polyisoprene homopolymers and the butadiene-isoprene copolymers.

Polymers based on one or more diene monomers which have a glass transition temperature Tg in the range of −60 to −100° C. are particularly preferred according to the invention.

In the context of this embodiment, preparations have proven to be advantageous which contain a content of polymers based on one or more diene monomers (b3) of 1 to 20 wt. %, in particular of 3 to 12 wt. %, in each case based on the total mass of the thermally expandable preparation.

The thermally expandable preparations according to the invention contain at least one peroxide as a third component that is essential to the invention. In particular, organic peroxides, for example ketone peroxides, diacyl peroxides, peresters, perketals and hydrogen peroxides, are preferred according to the invention. Particularly preferred are, for example, cumene hydroperoxide, t-butyl peroxide, bis(tert-butylperoxy)diisopropylbenzene, di(tert-butylperoxyisopropyl)benzene, dicumyl peroxide, t-butyl peroxybenzoate, dialkyl peroxydicarbonate, diperoxy ketals (e.g., 1,1-di-tert-butylperoxy-3,3,5-trimethylcyclohexane), ketone peroxides (e.g., methyl ethyl ketone peroxides), 4,4-di-tert-butylperoxy-n-butyl valerates and trioxepanes (e.g., 3,3,5,7,7-pentamethyl-1,2,4-trioxepane).

According to the invention, peroxides, commercially marketed for example by Akzo Nobel or Pergan, such as 3,3,5,7,7-pentamethyl-1,2,4-trioxepane, 2,5-dimethyl-2,5-di(tert-butylperoxy)hexane, di-tert-butyl peroxide, 2,5-dimethyl-2,5-di(tert-butylperoxy)hexane, tert-butyl cumyl peroxide, di-(tert-butylperoxyisopropyl)benzene, dicumyl peroxide, butyl-4,4-di(tert-butylperoxi)valerate, tert-butylperoxy-2-ethylhexyl carbonate, 1,1-di-(tert-butylperoxy)-3,3,5-trimethylcyclohexane, tert-butyl peroxybenzoate, di-(4-methylbenzoyl)peroxide and dibenzoyl peroxide, are particularly preferred.

It has also been found to be advantageous according to the invention for the peroxides used to be substantially inert at room temperature and to be activated only when heated to relatively high temperatures (for example when heated to temperatures of between 130° C. and 240° C.). It is particularly advantageous according to the invention for the peroxide used to have a half-life of more than 60 minutes at 65° C., i.e., after the thermally expandable preparation containing the peroxide has been heated to 65° C. for 60 minutes, less than half of the peroxide used has decomposed. According to the invention, peroxides that have a half-life of 60 minutes at 115° C. may be particularly preferred.

According to the invention, it can be particularly preferred to use di(tert-butylperoxyisopropyl) benzene as the peroxide; this is commercially available under the trade names Perkadox® 14-40 B-PD or Perkadox® 14-40 K PD from Akzo Nobel or under the trade name Peroxan® BIB 40 GS or Peroxan® BIB 40 P from Pergan. Furthermore, di(tert-butylperoxy)-3,3,5-trimethylcyclohexane is also particularly preferred as the peroxide; this can be commercially obtained as Trigonox® 29 from Akzo Nobel.

In another form according to the invention, it may also be preferred to use dicumyl peroxide, as is marketed, for example, under the trade names Perkadox® BC 40 K PD or Perkadox® BC 40 B PD from Akzo Nobel or under the trade names Peroxan® DC 40 GS, Peroxan® DC 40 P or Peroxan® DC 40 PK by Pergan.

Furthermore, a plurality of peroxides can also be used in combination, in particular those mentioned above as being preferred in combination.

According to the invention, it is also advantageous for the at least one peroxide or the peroxides to be used in a form in which they are applied to a solid inert carrier, such as calcium carbonate and/or silica and/or kaolin.

The at least one peroxide or the peroxides is/are contained in the thermally expandable preparations according to the invention preferably in an amount of 0.1 to 6 wt. %, more preferably 0.2 to 4.0 wt. %, in particular in an amount of 0.5 to 4.0 wt. %, in each case determined as the active substance content of peroxide based on the total mass of the thermally expandable preparation.

As a fourth component that is essential to the invention, the thermally expandable preparations according to the invention contain a thermally activatable blowing agent. Suitable thermally activatable blowing agents are, in principle, all known blowing agents, for example “chemical blowing agents” which release gases upon decomposition when subject to thermal treatment, or “physical blowing agents,” i.e., in particular thermally expandable hollow spheres. Chemical blowing agents are preferred according to the invention.

A chemical blowing agent is understood, according to the invention, to mean compounds which decompose upon exposure to heat and thereby release gases.

Examples of suitable chemical blowing agents are azo compounds, hydrazide compounds, nitroso compounds and carbazide compounds, such as azobisisobutyronitrile, azodicarbonamide (ADCA), di-nitroso-pentamethylene tetramine (DNPT), 4,4′-oxybis(benzenesulfonic acid hydrazide) (OBSH), 4-methylbenzene sulfonic acid hydrazide, azocyclohexylnitrile, azodiaminobenzene, benzene-1,3-sulfonylhydrazide, benzene-4-sulfonohydrazide (BSH), calcium azide, 4,4′-diphenyldisulfonyl azide, diphenyl-sulfone-3,3′-disulfohydrazide, diphenyloxide-4,4′-disulfohydrazide, benzene-1,3-disulfohydrazide, trihydrazinotriazine, 5-phenyltetrazole (5-PT), p-toluenesulfonylhydrazide (TSH) and p-toluenesulfonyl semicarbazide (PTSS).

Another class of suitable blowing agents are the H-silanes, which are marketed by Huntsmann, for example, under the trade name Foaming Agent DY-5054.

Furthermore, the carbamates described in DE-A1-102009029030 are particularly suitable as chemical thermally activatable blowing agents within the meaning of the present invention.

Endothermic chemical blowing agents, in particular selected from bicarbonates, solid, optionally functionalized, polycarboxylic acids and salts, and mixtures thereof, are also suitable. These endothermic blowing agents have the advantage that they are neither harmful to health nor explosive and that smaller amounts of volatile organic compounds (VOC) are formed during expansion. The decomposition products are largely CO₂ and water. Furthermore, the products produced therewith have a more uniform foam structure over the entire process temperature range used for curing. This can also result in lower water absorption. Finally, the decomposition temperature of the endothermic blowing agents, in particular of mixtures thereof, is lower compared with conventional exothermic blowing agents, and therefore the process temperature can be reduced and energy can be saved.

Suitable bicarbonates (hydrogen carbonates) are those of formula XHCO₃, where X can be any cation, in particular an alkali metal ion, preferably Na⁺ or K⁺, with Na⁺ being extremely preferred. Further suitable cations X⁺ can be selected from NH₄⁺, ½ ZN²⁺, ½ Mg²⁺, ½ Ca²⁺, and mixtures thereof.

Suitable polycarboxylic acids include, without being limited thereto, solid, organic di-, tri-, or tetraacids, in particular hydroxyl-functionalized or unsaturated di-, tri-, tetra-, or polycarboxylic acids, such as citric acid, tartaric acid, malic acid, fumaric acid and maleic acid. The use of citric acid is particularly preferred. Citric acid is therefore advantageous, inter alia, because it is an ecologically sustainable blowing agent.

The salts of the acids mentioned and mixtures of two or more of the compounds described are also suitable. In the case of salts of polycarboxylic acids, the counterion is preferably selected from the group comprising Na⁺, K⁺, NH₄⁺, ½ ZN²⁺, ½ Mg²⁺, ½ Ca²⁺, and mixtures thereof, Na⁺ and K⁺, in particular Na⁺, being preferred. In particular, the salts of polycarboxylic acids demonstrate decomposition temperatures that are shifted toward higher temperatures, so that a broader temperature interval for decomposition can be set by mixing.

When using polycarboxylic acids, carbonates can preferably also be used. A mixture of hydrogen carbonates and carbonates as well as polycarboxylic acids is preferred, as a result of which different activation stages and decomposition reactions can be set in a targeted manner.

Particularly preferred blowing agents are sodium bicarbonate and/or citric acid/citrate; the blowing agent is very particularly preferably a mixture of sodium bicarbonate and citric acid/citrate. Compared with conventional exothermic blowing agents such as ADCA or OBSH, such a mixture has a very low start temperature of only 120-140° C., whereas OBSH has a start temperature of 140-160° C. and ADCA, activated with zinc salts, has a start temperature of 160-170° C. and, not activated, of 210-220° C.

According to the invention, the chemical thermally activatable blowing agents are preferably contained in an amount of 0.1 to 20 wt. %, in particular of 0.7 to 15 wt. %, more preferably 3.0 to 12.0 wt. %, in each case based on the total application preparation.

The “chemical blowing agents” according to the invention can advantageously be used in combination with activators and/or accelerators, such as zinc compounds (for example zinc oxide, zinc stearate, zinc ditoluene sulfinate, zinc dibenzenesulfinate), magnesium oxide, calcium oxide and/or (modified) ureas. The zinc compounds are particularly preferred according to the invention.

According to the invention, it does not matter whether the blowing agents are already used in activated form or whether the thermally expandable preparations contain a corresponding activator and/or accelerator, such as zinc ditoluene sulfinate, in addition to the blowing agent.

It has proven particularly advantageous if the thermally expandable preparations according to the invention contain the activators and/or accelerators, in particular the zinc compounds, very particularly zinc oxide, in an amount of 0.5 to 5 wt. %, in particular of 0.5 to 2.5 wt. %, based on the total mass of the thermally expandable preparation.

Expandable plastics hollow microspheres based on polyvinylidene chloride copolymers or acrylonitrile-(meth)acrylate copolymers are preferably used as physical blowing agents. These are commercially available, for example, under the names “Dualite®” and “Expancel®” from Pierce & Stevens and Akzo Nobel, respectively.

It may be preferable according to the invention to use, in the thermally expandable preparations, a combination of at least one chemical thermally activatable blowing agent and at least one physical thermally activatable blowing agent.

The amount of blowing agent is preferably selected such that the volume of the thermally expandable compound, when heated to an activation temperature (or expansion temperature), increases irreversibly by at least 10%, preferably at least 50%, and in particular at least 100%. This means that, in addition to the normal and reversible thermal expansion according to the coefficient of thermal expansion of the compound, the volume of said compound, by comparison with the starting volume at room temperature (20° C.), irreversibly increases when heated to the activation temperature in such a way that, after being cooled back down to room temperature, it is at least 10%, preferably at least 50%, and in particular at least 100%, greater than before. The specified degree of expansion thus refers to the volume of the compound at room temperature before and after the temporary heating to the activation temperature. The upper limit of the degree of expansion, i.e., the irreversible increase in volume, can be set by selecting the amount of blowing agent. Preferred upper limits are in the range of up to 1,000%, preferably up to 750%. Preferred ranges are 250 to 750%.

The activation temperature is preferably in the range of 120 to 220° C. This temperature should preferably be maintained for a period of time in the range of 10 to 150 minutes.

As a fifth essential component, the thermally expandable preparations according to the invention contain at least 1 to 12 wt. %, preferably 2 to 10 wt. %, of at least one adhesion promoter (e), in particular selected from pre-crosslinked rubbers, preferably highly crosslinked butyl rubber.

Suitable rubbers are preferably solid rubbers having Mooney viscosities (determined at 127° C., preferably in accordance with DIN 53523) in the range of 60 to 80. Solid rubbers and have a significantly higher molecular weight (Mw=100,000 or higher) compared with liquid rubbers. Examples of suitable rubbers are polybutadiene, preferably having a very high proportion of cis-1,4 double bonds (typically above 95%), styrene butadiene rubber, butadiene acrylonitrile rubber, synthetic or natural isoprene rubber, butyl rubber or polyurethane rubber. Crosslinked butyl rubber is particularly preferred, in particular highly crosslinked butyl rubber, as is commercially available, for example, under the trade name Kalar®, in particular Kalar® 5275, from Royal Elastomers.

Finally, the preparations according to the invention can also contain a co-crosslinking agent which is selected from multifunctional (meth)acrylates, in particular low-molecular-weight multifunctional (meth)acrylates. A “low-molecular-weight multifunctional (meth)acrylate” is understood according to the invention to be a compound which has at least two (meth)acrylate groups and a molar weight of below 2,400 g/mol, preferably below 800 g/mol.

In particular compounds that have two, three or more (meth)acrylate groups per molecule have been found to be advantageous according to the invention.

Preferred difunctional (meth)acrylates are ethylene glycol dimethacrylate, diethylene glycol dimethacrylate, triethylene glycol dimethacrylate, triethylene glycol diacrylate, tripropylene glycol dimethacrylate, 1,4-butanediol-dimethacrylate, 1,3 butylene glycol dimethacrylate, 1,3-butanediol dimethacrylate, tricyclodecane dimethanol dimethacrylate, 1,10-dodecanediol dimethacrylate, 1,6-hexanediol dimethacrylate, 2-methyl-1,8-octanediol dimethacrylate, 1,9-nonanediol dimethacrylate, neopentyl glycol dimethacrylate and polybutylene glycol dimethacrylate.

Preferred low-molecular-weight (meth)acrylates having three or more (meth)acrylate groups are glycerol triacrylate, dipentaerythritol hexaacrylate, pentaerythritol triacrylate (TMM), tetramethylolmethane tetraacrylate (TMMT), trimethylolpropane triacrylate (TMPTA), pentaerythritol trimethacrylate, di(trimethylolpropane) tetraacrylate (TMPA), pentaerythritol tetraacrylate, trimethylolpropane trimethacrylate (TMPTMA), tri(2-acryloxyethyl)isocyanurate and tri(2-methacryloxyethyl)trimellitate and the ethoxylated and propoxylated derivatives thereof having a content of a maximum of 35 EO units and/or a maximum of 20 PO units.

According to the invention, thermally expandable preparations that contain a low-molecular-weight multifunctional (meth)acrylate selected from triethylene glycol diacrylate, triethylene glycol dimethacrylate, trimethylolpropane triacrylate (TMPTA) and trimethylolpropane trimethacrylate (TMPTMA), pentaerythritol triacrylate (TMM), tetramethylolmethane tetraacrylate (TMMT), pentaerythritol trimethacrylate, di(trimethylolpropane)tetraacrylate (TMPA) and pentaerythritol tetraacrylate are very particularly preferred.

It has been found to be particularly advantageous according to the invention for the thermally expandable preparations to contain at least one low-molecular-weight multifunctional (meth)acrylate selected from triethylene glycol diacrylate, trimethylolpropane triacrylate (TMPTA) and trimethylolpropane trimethacrylate (TMPTMA).

The multifunctional (meth)acrylates are contained in the thermally expandable preparations preferably in an amount of 0.1 to 3.5 wt. %, more preferably 0.2 to 2.5 wt. %, in particular of 0.4 to 1.4 wt. %, in each case based on the total mass of the thermally expandable preparation.

Use of the low-molecular-weight multifunctional (meth)acrylates has proven to be particularly advantageous according to the invention for the stability of the resulting foam when the thermally expandable preparations contain either just a small amount of the polymer (a) or just a small amount of peroxide.

In addition to the low-molecular-weight acrylates, the thermally expandable preparations may contain further co-crosslinking agents, such as allyl compounds, for example triallyl cyanurate, triallyl isocyanurate, triallyl trimesate, triallyl trimellitate (TATM), tetraallyl pyromellitate, the diallyl esters of 1,1,3-trimethyl-5-carboxy-3-(4-carboxyphenyl)indene, trimethylolpropane trimellitate (TMPTM) or phenylene dimaleimide.

In addition to the constituents according to the invention, the thermally expandable compounds can also contain other customary components, such as dyes, fillers and antioxidants.

Fillers include, for example, the various ground or precipitated chalks, calcium magnesium carbonates, talc, graphite, barite, silicic acid or silica and in particular silicate fillers such as mica, for example in the form of chlorite, or silicate fillers of the aluminum-magnesium-calcium silicate type, for example wollastonite. Talc is a particularly preferred filler.

The fillers are preferably used in an amount of 0 to 60 wt. %, in particular 5 to 18 wt. %, in each case based on the mass of the entire thermally expandable preparation.

Chromophoric components, in particular black dyes based on carbon blacks, are preferably contained in the thermally expandable preparations according to the invention in an amount of 0 to 8 wt. %, in particular of 0.1 to 4 wt. %, in each case based on the mass of the entire thermally expandable preparation.

It is possible to use, for example, sterically hindered phenols and/or sterically hindered thioethers and/or sterically hindered aromatic amines, for example bis-(3,3-bis-(4′-hydroxy-3-tert-butylphenyl)butanoic acid)glycol ester, as antioxidants or stabilizers.

Antioxidants or stabilizers are preferably contained in the thermally expandable preparations according to the invention in an amount of 0 to 2 wt. %, in particular of 0.1 to 0.5 wt. %, in each case based on the mass of the entire thermally expandable preparation.

In a further preferred embodiment, the preparations according to the invention contain at least one flame retardant. By using the flame retardants, it is possible to use the preparations according to the invention for stiffening and/or reinforcing in the region of passenger compartments and at the same time reduce the risk of fire in these regions.

The flame retardant is preferably selected from the group of halogenated (in particular brominated) ethers of the “Ixol” type from Solvay, brominated alcohols, in particular dibromoneopentyl alcohol, tribromoneopentyl alcohol and PHT-4-diol (1,2-benzene dicarboxylic acid, 3,4,5,6-tetrabromo-2-(2-hydroxyethoxy)ethyl-2-hydroxypropyl ester), organic phosphates, in particular diethyl ethane phosphonate (DEEP), triethyl phosphate (TEP), dimethyl propyl phosphonate (DMPP), diphenyl cresyl phosphate (DPK), and chlorinated phosphates (for example tris(1-methyl-2-chloroethyl)phosphate (TMCP), Albemarle), in particular tris(2-chloroethyl)phosphate, tris(2-chloroisopropyl)phosphate (TCPP), tris(1,3-dichloroisopropyl)phosphate, tris(2,3-dibromopropyl)phosphate and tetrakis(2-chloroethyl)ethylene diphosphate, or mixtures thereof.

Further flame retardants that are preferred according to the invention are elemental red phosphorus, polyphosphate compounds such as melamine polyphosphate and/or ammonium polyphosphate, aluminum trihydrate (ATH), “expandable graphite” and dihydrooxaphosphaphenanthrene oxide (DOPO).

The preparation according to the invention preferably contains the flame retardant in an amount of 1 to 30 wt. % based on the total pumpable, thermally expandable preparation. Contents of flame retardants in the range of 5 to 25 wt. %, in particular of 15 to 20 wt. %, are particularly preferred, based on the total pumpable, thermally expandable preparation.

The thermally expandable preparations according to the invention can be prepared by mixing the selected components in any suitable mixer, for example a dispersion mixer, a planetary mixer, a twin-screw mixer, a continuous mixer or an extruder, in particular a twin-screw extruder.

Although it can be advantageous to heat the components slightly to make it easier to achieve a homogeneous and uniform compound, care must be taken to ensure that temperatures which cause the thermally activatable curing agent and/or the thermally activatable blowing agent to be activated are not reached.

The thermally expandable preparations according to the invention are preferably formulated such that they are solid at 20° C. A thermally expandable preparation is referred to as “solid” according to the invention if the geometry of this composition does not deform under the influence of gravity at the indicated temperature within 1 hour, in particular within 24 hours.

Until they are used, the preparations according to the invention are preferably stored in nozzle cartridges or barrels, such as sealed drums.

At the time of use, the preparation according to the invention is transported from the storage container to the application site and is applied at said site using conventional heated pumps. Said preparation can be applied to a layer thickness of 5 cm without difficulty, such that even relatively large cavities, such as tubes having a corresponding internal diameter, can easily be filled.

The thermally expandable preparation applied expands by being heated, the preparation being heated for a particular time period and to a particular temperature which is sufficient for bringing about the activation of the blowing agent and the curing agent.

Depending on the composition of the preparation and the requirements of the production line, these temperatures are usually in the range of 130° C. to 240° C., preferably of 150° C. to 200° C., with a residence time of 10 to 90 minutes, preferably of 15 to 60 minutes.

In principle, the type of the heat source is not important, and so the heat can be supplied for example by a hot air blower, by irradiation with microwaves, by magnetic induction, or by heating tongs. In the field of vehicle construction and in fields of technology involving associated production processes, it is particularly advantageous for the preparations according to the invention to expand when the vehicle passes through the furnace for curing the cathodic dip paint or for baking the powder coatings, and therefore a separate heating step can be dispensed with.

The present invention secondly relates to a method for stiffening and/or reinforcing structural components having thin-walled structures, in particular tubular structures, and/or for sealing cavities in structural components. In such methods, a pumpable, thermally expandable preparation according to the invention can be applied to the surface of the structure to be reinforced or introduced into the cavity of the structural component to be sealed at a temperature below 120° C., preferably at a pump pressure of less than 200 bar, and this preparation can be cured at a later point in time, preferably at temperatures above 130° C. The curing leads to the thermally expandable preparation expanding, thus stiffening the structural component/sealing the cavity.

According to the invention, the preparations are particularly preferably applied in a temperature range of 50° C. to 80° C. Application at an application pressure of 6 bar to 180 bar is also particularly preferred.

The actual curing takes place according to the invention at a “later point in time.” For example, according to the invention, it is conceivable that the structural components to be stiffened or sealed be coated/filled with the pumpable, thermally expandable preparations and then put into intermediate storage. Intermediate storage may also include, for example, transportation to another plant. Such intermediate storage can last up to several weeks.

In another embodiment, however, it is also conceivable that the structural components to be stiffened or sealed be subject to a curing step shortly after being coated/filled with the pumpable, thermally expandable preparation. This may take place immediately or, in the case of assembly-line production, after the components have arrived at one of the subsequent stations. In the context of this embodiment, it is particularly preferable according to the invention for the curing step to take place within 24 h, in particular within 3 h, after the preparations according to the invention have been applied.

The pumpable, thermally activated foams according to the invention can be used in all products which have cavities or have tube structures to be reinforced. In addition to vehicles such as aircraft, these products include domestic appliances, furniture, buildings, walls, partitions or boats, and all devices having a supporting frame structure formed of tubes, for example sports equipment, mobility aids, frameworks and bicycles.

Examples of sports equipment in which the present invention can be used advantageously are bicycles, fishing nets, fishing rods, goal posts, tennis net posts, and basketball hoop structures.

According to the invention, the term “bicycle” is understood to be any usually two-wheeled, single-track vehicles driven by operating pedals.

In addition to the conventional bicycle structures in which the rider adopts a seated position, recumbent bicycles, for example, are also intended to be included according to the invention. In addition to the conventional fixed frame, structures comprising hinges, such as folding bicycles, are also included according to the invention. Vehicles having three or more wheels are also intended to be included.

The preparations according to the invention can, for example, reinforce the constituents of a diamond frame, a sloping frame, a truss frame, a cross frame, a trapezoidal frame, an anglais frame, a gooseneck frame, a wave frame, an easy boarding frame or a Y frame.

Furthermore, the preparations according to the invention can be used to reinforce the frame structures of mobility aids, such as wheelchairs, rollators, crutches, assistive canes or walking frames.

In the field of vehicle construction, the use of the preparations according to the invention has been found to be advantageous particularly for the construction of the driver's safety cage or the passenger compartment, since it can provide the structure with a large amount of stability and, at the same time, a low weight. The preparation according to the invention can be used advantageously in particular in the construction of all classes of racing cars (Formula 1, touring cars, rally vehicles, etc.).

Another preferred field of application of the present invention is the field of tools. There are no fundamental restrictions with regard to the type of tools. For example, said tools may be tradesmen's equipment, specialist tools, gardening equipment, such as spades or wheelbarrows, or kitchen equipment. Common to all these structural components is the fact that the preparation according to the invention makes it possible to stabilize the structure without significantly increasing the total weight.

Furthermore, the preparations according to the invention can advantageously be used to stabilize frames. According to the invention, “frames” are understood to be lateral surrounds, such as picture frames, window frames or door frames.

Another field of application is the reinforcement of all types of frameworks. In this field of application too, a high level of stability of the accordingly reinforced structures is paramount. The frameworks in which the preparation according to the invention can be used include, for example, all types of ladders, and also construction site scaffolding, structural frameworks for exhibition stand construction, structures for concert stages, such as supporting and mounting structures used as crossbeams, and lighting poles for stadiums or spectator stands.

Another broad field of application is the field of street furniture. This field includes traffic light and lighting systems as well as all other structures, such as bus shelters, platform railings, seat structures, road signs, bicycle stands or crash barriers.

With regard to the further details of this subject of the present invention, what has already been said in relation to the first subject applies, mutatis mutandis.

The present invention thirdly relates to the use of a pumpable, thermally expandable preparation according to the invention for stiffening and/or reinforcing structural components having thin-walled structures, in particular tubular structures, and to the use of a pumpable, thermally expandable preparation according to the invention for (acoustically) sealing cavities in structural components and/or for sealing cavities in structural components against water and/or moisture.

With regard to the details of this subject of the present invention, what has already been said in relation to the other subjects applies, mutatis mutandis.

The present invention fourthly relates to a structural component which optionally has a thin-walled structure and has been stiffened and/or reinforced and/or sealed by means of curing using a preparation according to the invention.

All embodiments disclosed in connection with the preparations of the inventions can also be transferred to the methods and uses and vice versa.

The following examples are intended to explain the invention in greater detail; the selection of the examples should not limit the scope of the subject of the invention.

### EXAMPLES

### 1. Production of the Formulas

The following thermally expandable preparations were produced. Unless otherwise noted, the quantitative data are given in weight percent.

TABLE 1

| | Formulation | | | | | | | | | | |
|---|---|---|---|---|---|---|---|---|---|---|---|
| Raw material | F1 | F2 | F3 | F4 | F5 | F6 | F7 | F8 | F9 | F10 | F11 |
| Lotader AX 8900 | 11.0 | 11.0 | 12.0 | 12.0 | — | 18.5 | 12.0 | 12.0 | 12.0 | 12.0 | — |
| Lotader AX 8700 | — | — | — | — | — | — | — | — | — | — | 18.5 |
| Elvaloy 4170 | 5.5 | 5.5 | 6.5 | 6.5 | 18.5 | — | 6.5 | 6.5 | 6.5 | 6.5 | — |
| Kuraray LIR 390 | 8.0 | 8.0 | 8.0 | 8.0 | 8.0 | 8.0 | 8.0 | 8.0 | 8.0 | 8.0 | 8.0 |
| Novares TN 15 | 26.0 | 26.0 | — | — | — | — | — | — | — | — | — |
| Piccotac 1020 E | — | — | 26.0 | 26.0 | 26.0 | 26.0 | 26.0 | 26.0 | 28.0 | 28.0 | 25.5 |
| Oppanol B 10 N | 5.3 | — | 5.3 | 5.3 | 5.3 | 5.3 | 5.3 | 5.3 | 6.3 | 6.3 | 6.3 |
| Kalar 5275 | 8.0 | 8.0 | 8.0 | 8.0 | 8.0 | 8.0 | 8.0 | 8.0 | 8.0 | 4.0 | 2.0 |
| Prododin B50/70 | — | 5.3 | — | — | — | — | — | — | — | — | — |
| Luzenac 2 | 11.5 | 11.5 | 11.5 | 11.5 | 11.5 | 11.5 | 12.0 | 12.0 | 12.0 | 16.0 | 20.0 |
| Lamp Black 101 | 3.0 | 3.0 | 3.0 | 3.0 | 3.0 | 3.0 | 3.0 | 3.0 | 3.0 | 3.0 | 3.0 |
| Tracel OBSH 80PR | 10.0 | 10.0 | 8.0 | 8.0 | 8.0 | 8.0 | 8.0 | 8.0 | 8.0 | 8.0 | 8.5 |
| Trigonox 29-40B-GR-E | 0.5 | 0.5 | 0.5 | 0.5 | 0.5 | 0.5 | — | — | — | — | — |
| Peroxan BIB-40P | — | — | — | — | — | — | — | — | — | — | 1.0 |
| Perkadox BC-40B/ | 4.0 | 4.0 | 4.0 | 4.0 | 4.0 | 4.0 | 4.0 | 4.0 | 2.0 | 2.0 | 1.0 |
| Peroxan DC-40GS | | | | | | | | | | | |
| SR350 | 3.0 | 3.0 | 3.0 | | 3.0 | 3.0 | 3.0 | | | | |
| SR351 | | | | 3.0 | | | | 3.0 | 2.0 | 2.0 | 2.0 |
| Hostanox O3 | 0.2 | 0.2 | 0.2 | 0.2 | 0.2 | 0.2 | 0.2 | 0.2 | 0.2 | 0.2 | 0.2 |
| CaO Precal 30S | 2.0 | 2.0 | 2.0 | 2.0 | 2.0 | 2.0 | 2.0 | 2.0 | 2.0 | 2.0 | 2.0 |
| ZnO | 2.0 | 2.0 | 2.0 | 2.0 | 2.0 | 2.0 | 2.0 | 2.0 | 2.0 | 2.0 | 2.0 |
| Total | 100 | 100 | 100 | 100 | 100 | 100 | 100 | 100 | 100 | 100 | 100 |
| Expansion rate (bead) | | | | | | | | | | | |
| in % | F1 | F2 | F3 | F4 | F5 | F6 | F7 | F8 | F9 | F10 | F11 |
| 15 minutes, 160° C. | 731 | 1006 | 743 | 540 | 680 | 368 | 443 | 631 | 651 | 626 | 573 |
| 15 minutes, 180° C. | 696 | 806 | 659 | 527 | 672 | 374 | 549 | 651 | 621 | 538 | 601 |
| 40 minutes, 200° C. | 578 | 669 | 405 | 410 | 403 | 311 | 570 | 532 | 554 | 491 | 493 |
| Wash-off resistance | 0 | 0 | 0 | 0 | 0 | 0 | 1 | 1 | 0 | 0 | 0 |
| Melting point (° C.) | | 53.3- | >75 | >75 | >75 | >75 | >75 | >90 | >90 | 64.5- | 61.5- |
| | | 54.1 | | | | | | | | 65.5 | 62.4 |

### 2. List of the Commercial Products Used

| | |
|---|---|
| Lotader AX 8900 | ethylene-acrylic ester-glycidyl methacrylate terpolymer, methyl |
| (terpolymer) | acrylate content 24 wt. %, glycidyl methacrylate content 8 wt. %, |
| | melting point 65° C., MFI 6 g/10 min (190° C., 2.16 kg) |
| Lotader AX 8700 | terpolymer (GMA/EBA), reactive ethylene terpolymer, 6-9 wt. % |
| (terpolymer) | glycidyl methacrylate, 23-28 wt. % butyl acrylate, melting point 72° C., |
| | MFI 7-11 g/10 min (190° C., 2.16 kg)) |
| Elvaloy 4170 | terpolymer (GMA/EBA), reactive ethylene terpolymer, 9 wt. % glycidyl |
| (terpolymer) | methacrylate, 20 wt. % butyl acrylate, melting point 72° C., MFI |
| | 8 g/10 min (190° C., 2.16 kg)) |
| Kuraray LIR 390 | liquid butadiene-isoprene copolymer, Mw 48,000, density 0.88 g/cm³ |
| Novares TN 15 | liquid hydrocarbon resin |
| Piccotac 1020 E | liquid low-molecular-weight hydrocarbon resin based on petroleum- |
| | based aliphatic monomers, Mw 1750, viscosity Brookfield LVTD, |
| | spindle 31 30,000 mPas (30° C.) acc. ISO 2555 |
| Oppanol B 10 N | liquid polyisobutylene, Mw 36,000, Mw/Mn 4.0 |
| Kalar 5275 | pre-crosslinked butyl rubber, Mooney viscosity ML |
| | 1 + 3 (127° C.) 65-72, density 0.92 g/cm³ |
| Prododin B50/70 | bitumen |
| Luzenac 2 | Talc, density 2.78 g/cm³, particle size 2-20 μm |
| Lamp Black 101 | carbon black, BET 21 m² |
| Tracel OBSH 80PR | diphenyloxide-4,4'-disulfohydrazide, content 80%, decomposition |
| (blowing agent) | temperature approximately 160° C., gas yield 125 mL/g |
| Trigonox 29-40B-GR-E | 1,1-di(tert-butylperoxy)-3,3,5-trimethylcyclohexane, content 39-41 |
| | wt. %, 10.58% active oxygen, half-life temperature 1 h = 117° C., |
| | t90 = 145° C. (rheometer t90 approximately 12 min) |
| | di-(2-tert-butyl-peroxyisopropyl)benzene, content 39-41 wt. %, 3.78% |
| Peroxan BIB-40P | active oxygen, half-life temperature 1 h = 14° C., t90 = 175° C. |
| | (rheometer t90 approximately 12 min) |
| Perkadox BC-40B/ | dicumyl peroxide, content 39-41 wt. %, 5.92% active oxygen, |
| Peroxan DC-40GS | half-life temperature 1 h = 1138° C., t90 = 170° C. (rheometer |
| | t90 approximately 12 min) |
| SR350 | trimethylolpropane trimethacrylate TMPTMA, density 1.06 g/cm³, |
| | colorless liquid |
| SR351 | TRIMETHYLOLPROPANE TRIACRYLATE, density 1.1 g/cm³, |
| Hostanox O3 | bis[3,3-bis-(4'-hydroxy-3'-tert-butyl phenyl)butanoic acid]glycol ester, |
| | molecular weight 794 g/mol, melting point 167-171° C. |
| CaO Precal 30S | calcium oxide, > 97 wt. % content, bulk density 0.8 kg/dm³ |
| ZnO | zinc oxide, content > 99.5 wt. %, BET surface area 10 m²/g, density |
| | 5.47 g/cm³ |

To produce the thermally expandable preparations according to the invention, the polymers and resins contained were processed step-by-step with fillers at RT in a kneader or, if necessary, with heating to up to 150° C. to form a homogeneous dough. The other non-reactive components such as fillers, carbon black, stabilizers and plasticizers, if any, were then added one after the other and kneaded further until the formulation was smooth.

At below 60° C., all reactive components such as accelerators, peroxides, activators and catalysts, zinc oxide, calcium oxide and blowing agent were then added and slowly kneaded in until the adhesive was homogeneously mixed. Finally, the mixtures were homogenized for a further 10 minutes under a vacuum of less than 100 mbar and filled into cartridges.

### 3. Determination of the Properties of the Preparation

### Determination of Expansion

To determine the expansion, test specimens having dimensions of approximately 20 mm×8-10 mmo round bead portions were pressed out of the cartridges produced from the example formulations at approximately 60-90° C. and these were introduced into a convection oven, which was heated to the temperatures specified in the tables (heating time approximately 7 to 10 minutes). The test specimens were then left at this temperature for the period specified in the tables (including heating time). The expansion at 180° C. corresponds to the ideal conditions that are achieved during curing in vehicle construction. The expansion at 160° C. simulates the underfiring conditions and the expansion at 200° C. simulates the overfiring conditions.

The degree of expansion [%] was determined by the water displacement method according to the formula

$$Expansion = \frac{( m 2 - m 1 )}{m 1} \times 100$$

m1=mass of the test specimen in its original state in deionized water
m2=mass of the test specimen determined after baking in deionized water.

### Determination of Washout Resistance

To determine the washout resistance, round beads having a geometry of 150 mm×8-10 mmo were applied at 60-90° C. to a prepared metal sheet of approximately 200 mm×30 mm and cooled for at least 1 h. The metal sheet prepared in this way is clamped in a holder of a rod agitator having a 12 cm radius, and immersed in a bath at 55° C., the rod agitator is set to a speed of rotation of 60 min⁻¹ and started. After 10 minutes the stirrer is switched off and the sample holder is lifted out of the water. The samples are removed from the holder and assessed. At least three test specimens are to be made.

The evaluation is based on the following rating scale:

0=unchanged compared with the initial state
1=little deformation
2=significant deformation without material washout
3=strong deformation, but without material washout
4=very strong deformation with material washout
5=material removal, but the originally wetted area is still covered with material
6=almost complete material removal except for small residual amounts

1. A thermally expandable preparation which can be pumped at application temperatures in a range of 50° C. to 120° C., and contains, in each case based on a total weight of the preparation:
(a) 3 to 40 wt. % of at least one polymer, optionally comprising a peroxidically crosslinkable polymer, the at least one polymer being selected from:
(a1) binary copolymers containing at least one monomer unit selected from vinyl acetate, (meth)acrylic acids, styrene and derivatives thereof, and
(a2) terpolymers based on at least one first monomer selected from monounsaturated or polyunsaturated hydrocarbons, and at least one second monomer selected from (meth)acrylic acids and derivatives thereof, and at least one third monomer selected from epoxy-functionalized meth(acrylates); and combinations of (a1) and (a2);
(b) 1 to 40 wt. % of at least one liquid polymer selected from:
(b1) liquid hydrocarbon resins;
(b2) liquid polyolefins; and
(b3) liquid polymers based on one or more diene monomers;
(c) 0.1 to 6 wt. % of at least one peroxide;
(d) 0.1 to 20 wt. % of at least one thermally activatable blowing agent;
(e) 1 to 12 wt. % of at least one adhesion promoter, selected from pre-crosslinked rubbers; and
(f) 0 to 6 wt. % of at least one co-crosslinking agent selected from multifunctional (meth)acrylates.

2. The thermally expandable preparation of claim 1, wherein the at least one first monomer of (a2) comprises ethylene, the at least one second monomer of (a2) comprises (meth)acrylic esters, and the at least one third monomer of (a2) comprises glycidyl (meth)acrylate; and (f) is present in an amount of 0.1 to 3.5 wt. % and comprises low-molecular-weight multifunctional (meth)acrylates.

3. The thermally expandable preparation of claim 1, wherein the peroxidically crosslinkable polymer is present in (a1) and is selected from styrene-butadiene block copolymers, styrene-isoprene block copolymers, ethylene-vinyl acetate copolymers, functionalized ethylene-vinyl acetate copolymers, functionalized ethylene-butyl acrylate copolymers, ethylene-methyl acrylate copolymers, ethylene-ethyl acrylate copolymers, ethylene-butylacrylate copolymers, functionalized ethylene-butylacrylate copolymers, ethylene-(meth)acrylic acid copolymers and ethylene-2-ethylhexyl acrylate copolymers.

4. The thermally expandable preparation according to claim 3, wherein (a1) comprises an ethylene-vinylacetate copolymer; and the terpolymer (a2) contains ethylene as the first monomer unit, a (meth)acrylic ester as the second monomer unit, and a glycidyl (meth)acrylate as the third monomer unit.

5. The thermally expandable preparation according to claim 1, wherein the polymer (b) is selected from petroleum-based liquid hydrocarbon resins, polyisobutylene, butadieneisoprene copolymers, and combinations thereof.

6. The thermally expandable preparation according to claim 1, wherein said preparation contains a sulfonic acid hydrazide and/or azodicarbonamide as the blowing agent.

7. The thermally expandable preparation according to claim 1, wherein the adhesion promoter (e) is selected from butyl rubbers, optionally highly crosslinked butyl rubbers.

8. The thermally expandable preparation according to claim 1, wherein the preparation further comprises fillers, antioxidants, activators and/or dyes.

9. A method of stiffening and/or reinforcing a structural component or of sealing a cavity in a structural component, comprising applying the thermally expandable preparation according to claim 1 to a surface of the structural component to be reinforced or to a cavity surface of a structural component cavity to be sealed, at a temperature below 120° C., at a pump pressure of less than 200 bar; and subsequently curing the thermally expandable preparation at a later point in time, at temperatures above 130° C.

10. The structural component, optionally having a thin-walled structure, stiffened and/or reinforced and/or sealed according to the method of claim 9.
